(19) United States
(12) Patent Application Publication
(10) Pub. No.: US 2008/0034839 A1
(43) Pub. Date: Feb. 14, 2008

(54) Method and Device for Monitoring Particle Concentration in Gas Stream

(76) Inventors: Johannes Ante, Regensburg (DE); Thomas Hammer, Hemhofen (DE); Thomas Kappes, Erlangen (DE)

Correspondence Address: STAAS & HALSEY LLP, SUITE 700, 1201 NEW YORK AVENUE, N.W., WASHINGTON, DC, 20005, US

(21) Appl. No.: 10/589,801

(22) PCT Filed: Feb. 7, 2005
(86) PCT No.: PCT/EP05/50516

§ 371 Date: May 15, 2007

(30) Foreign Application Priority Data
Feb. 17, 2004 (DE) 10 2004 007 634.0

(51) Int. Cl. G01N 7/02

(52) U.S. Cl. 73/23.31; 73/28.02

(57) ABSTRACT

Particle concentration is monitored in a gas stream, in particular rust particle concentration in the exhaust gas stream of an internal combustion engine. A sensor in the gas stream collects the particles that are monitored. The sensor is integrated as a capacitive element in an electromagnetic resonant circuit excited by an alternating voltage. The sensor includes a non-conducting base body and two electrodes spaced apart from each other. A characteristic value of the resonant circuit varying on the basis of the particle load of the sensor is determined as a reference value when the sensor is unloaded. The change in the characteristic value due to the particle load is determined relative to the reference value.

### CROSS REFERENCE TO RELATED APPLICATIONS

This application is based on and hereby claims priority to German Application No. 10 2004 007 634.0 filed on Feb. 17, 2004, the contents of which are hereby incorporated by reference.

### BACKGROUND

The invention relates to a method and a device for monitoring the particle concentration in a gas stream, in particular of soot particles in the exhaust gas stream of an internal combustion engine.

The regulations relating to the emission of pollutants in motor vehicles are becoming increasingly strict. Measures for reducing the raw emission of the engine by optimizing the combustion process are often not sufficient in this context. In particular, diesel engines have high emissions of soot particles. These can be reduced by engine-side measures only at the cost of an increased emission of nitrogen oxides. It is therefore appropriate to reduce the emission of particles using exhaust gas post-treatment. Modern particle filter systems reach a very high efficiency level in this context with a deposition level of over 95%.

Owing to various causes, such a soot particle filter may be faulty or become faulty during operation such that it allows an increased quantity of soot particles to pass through. In order to be able to detect such a malfunction, it is necessary to measure the particle concentration in the gas stream downstream of the filter. For this purpose, a suitable sensor is expediently permanently installed in the exhaust gas section.

A method for determining the soot concentration in the exhaust gas which makes use of the electrical conductivity of soot particles, and a corresponding sensor are known, for example, from WO 84/003147 A1. The particles are deposited here on a carrier made of nonconductive material on whose surface two metallic electrodes are mounted at a defined distance. In order to measure the soot load of the sensor surface, a voltage in the range between 10 V and 100 V is applied to the sensor with an electrode spacing of less than 1 mm, and the current which flows between the two electrodes through the soot layer is measured. It is disadvantageous that the sensor has a low degree of sensitivity and a high degree of susceptibility to faults at very low particle concentrations since there has to be a continuous layer of soot between the electrodes for a current to flow at all. Since the electrodes are thus subjected directly to the exhaust gas stream and the soot particles, the service life of the sensor is also limited because of electrode erosion.

### SUMMARY

A sensor which collects particles is placed in a gas stream. The sensor is integrated as a capacitive element in an electromagnetic resonant circuit. The resonant circuit is excited with an alternating voltage. The capacitive and resistive properties of the sensor are influenced here by the particle load of the sensor. As a result, at least one characteristic variable of the resonant circuit changes. This characteristic variable is determined as a reference value when the sensor is not loaded. The change in the characteristic variable which is brought about by the particle load compared to the reference value is then determined.

Since the sensor is placed in the gas stream, it is subjected to the particles which are carried along by the gas stream, for which reason a greater or smaller amount of particles are deposited on the sensor depending on the total quantity of particles present in the gas stream. The quantity of deposited particles is thus a measure of the total particles contained in the gas stream, that is to say the particle concentration.

The electromagnetic resonant circuit is, for example, a series oscillating circuit which is constructed essentially from a capacitor and an inductor. Instead of the capacitor, the sensor is integrated into the resonant circuit. The equivalent circuit diagram of the sensor is here a parallel circuit composed of a capacitor and an ohmic resistor, the values of the capacitor and ohmic resistor changing as a result of the quantity of particles deposited on the sensor. Since the characteristic variables of the resonant circuit depend on the variables of the components contained therein, various characteristic variables of the entire resonant circuit, for example its resonant frequency, quality or overall impedance, change when the sensor is loaded with particles. Such a characteristic variable thus serves as a measure of the particle load of the sensor.

Even very small depositions of particles on the sensor already bring about initially small changes in the sensor properties, that is to say the values of its resistance or its capacitance. However, due to the effect of the amplification of the resonant circuit in the case of resonance, these depositions bring about large changes in suitable characteristic variables, for example the resonant frequency or the excessive increasing of the voltage at the capacitor. Since the properties of the sensor are measured indirectly by these characteristic variables, the sensitivity of method is increased significantly compared to a resistance measurement with the known method. In addition, the method also functions when there are very small accumulations on the sensor, even if there is still no “coherent” conductive particle layer on the sensor since the capacitive properties of the sensor already change even as a result of very small quantities of particles, and even these changes can be sensed by the method.

The resonant circuit may be excited with alternating voltage with a fixed frequency and fixed amplitude and the voltage dropping across the sensor is determined as a characteristic variable. By this indirect measurement it is possible, owing to the excessive increasing of the voltage occurring at the capacitor, to determine the change in the resistance and the capacitance of the sensor significantly more precisely than via a direct measurement without a resonant circuit. The frequency of the exciting voltage only needs to lie approximately in the region of the resonant frequency of the resonant circuit.

Alternatively, the resonant frequency of the resonant circuit may determined as a characteristic variable. This can take place in various ways, for example with the values sweeping through the frequency range in question, the locating of the maximum voltage at the sensor and the determination of the frequency associated with the maximum voltage.

In a particularly simple implementation, if the frequency of the alternating voltage exciting the resonant circuit is tuned to the respective resonant frequency of the resonant circuit or adjusted in accordance with it. The resonant frequency is determined as a characteristic variable, which is particularly easy in this case since it corresponds to the frequency of the exciting voltage. Frequencies can generally be determined very precisely, as a result of which a very precise determination of the load-dependent sensor properties is possible in an indirect way. The frequency of the exciting voltage can also be tuned to the resonant frequency of the resonant circuit in a very easy way since in the case of resonance the voltage which drops across the sensor does not change when the frequency is slightly detuned.

Usually, in an exhaust gas stream, in addition to particles there are often further substances, for example oil residues or hydrocarbons with a high boiling point, which can become deposited on the sensor and disrupt the measurement. For this reason, in an advantageous development of the method the sensor is heated during the determination of the characteristic variable to a temperature below the ignition temperature of the particles. If the temperature is sufficiently high, impurities which adhere to the sensor are thus removed, without however burning particles and thus also removing them. If the sensor is heated, for example, to a temperature of approximately 200° C., no condensate of oil residues or hydrocarbons with a high boiling point can become deposited on it and disrupt the measurement signal of the sensor. In the hot state of the sensor, such substances pass through the sensor without becoming deposited on it. However, the particles which are deposited on the sensor are retained and their concentration can still be determined.

If, before the characteristic variable is determined, the sensor is heated to a temperature above the ignition temperature of the particles, a further preferred variant of the method is obtained. The ignition temperature of the soot particles in the exhaust gas of diesel engines is, for example, approximately 550° C. The particles which are deposited on the sensor burn at this temperature and the entire particle load of the sensor is thus removed. After the sensor is heated, it is therefore free again of particles. A directly imminent determination of the characteristic variable thus again supplies a reference value for the sensor without loading. Since the reference value can be determined again at any time by this method variant, it is possible to compensate for fabrication tolerances of the sensor or for changes in its electrical properties over time.

A device for carrying out the method includes a sensor which is placed in the exhaust gas stream. The latter is embodied in such a way that it accumulates particles on itself from the gas stream which flows past it. It is integrated as a capacitive element into an electromagnetic resonant circuit which is excited with alternating voltage. The sensor has a nonconductive base body and two electrodes which are mounted on it spaced apart from one another. As a result of the electrodes which are insulated from one another, a capacitance is formed between them, for which reason the sensor has capacitive properties. When alternating voltage is applied to it, alternating current therefore flows through the sensor. When the sensor is loaded with particles, that is to say there is an accumulation of electrically conductive particles on the nonconductive body in the electrical field region of the electrodes, the electrical alternating voltage properties of the sensor change. When alternating voltage is applied to the sensor, for example electrical losses are generated in the particles, which is perceptible through a rise in the loss angle of the sensor capacitance as the particle load increases. In the equivalent circuit diagram of the sensor composed of a capacitor with a resistor connected in parallel, this causes the value of the ohmic resistance to drop.

Owing to the application of the alternating voltage, this does not require a continuous direct current path between the electrodes, which would correspond to a continuous layer of soot. The particles or particle layer also do not need to be in electrical contact with the electrodes. Even small quantities of deposited particles which do not form a closed conductive layer thus lead to a change in the electrical properties of the sensor. As already mentioned above, these very small changes in the electrical properties owing to the integration of the sensor into the resonant circuit when a few particles are deposited can be determined very precisely as a measure of the particle concentration present in the gas stream by the indirect measuring methods specified above.

The base body is preferably composed of high-quality ceramic or quartz glass. This ensures that the sensor is stable with respect to temperature and robust in order to withstand the extreme ambient conditions in the exhaust gas stream of an internal combustion engine. Furthermore, the smallest quantities of particles which have become deposited thus also change the electrical properties of the sensor since the particles bring about significantly higher dielectric losses than the base body.

In a further embodiment variant, the base body is composed of porous material. As a result, in contrast to a base body made of a material with a smooth or dense surface, particles to be detected can become adhered significantly better to the sensor and be secured or stored on it or in it. The greater number of adhering particles increases the sensitivity of the sensor significantly.

Owing to the integration of the sensor in a resonant circuit, there is, as mentioned above, no need for a direct current connection between the electrode and the conductive particles or conductive layer of soot. In one advantageous embodiment variant, the electrodes can therefore be embedded in the base body. The particles or the particle layer is then coupled capacitively to the electrodes. The embedding of the electrodes in the base body means that they are not directly subjected to the gas stream, which significantly lengthens their service life, and particularly in the case of an exhaust gas stream of an internal combustion engine they are not subjected to the aggressive exhaust gas.

A further possible way of protecting the electrodes involves arranging them on a side of the base body which is inaccessible to particles. This can be done, for example, by embedding the base body in the side wall of the pipe which conducts the gas stream so that one of its sides, on which particles can become deposited, reaches into the gas stream, and the electrodes are arranged on its outer side which is in contact only with ambient air, that is to say outside the gas-conducting pipe. The electrodes are in this case also well protected and the manufacture of the sensor is simplified compared to embedding electrodes in the sensor material.

Equipping the sensor with a heating device results in a further embodiment variant. Thus, the sensor can easily be heated to different temperatures in order to carry out the method variants described above. The heating device can, for example, be a simple electrical heating resistance coil which is not in contact with the electrodes and which is mounted on the outside or embedded in the sensor.

In a further embodiment variant, the base body is provided with a catalytically active layer at least in the region which can be reached by particles. Oxides of various materials such as vanadium, silver, manganese or cerium are examples of suitable catalysts. Such a catalytically active layer reduces, for example, the ignition temperature of soot particles by approximately 150° C. to 400° C. Therefore, in order to clean the sensor from a particle load by heating, it is no longer necessary to heat it so much, which reduces the thermal stress to which it is subjected, and thus its service life.

### BRIEF DESCRIPTION OF THE DRAWINGS

For a further description These and other objects and advantages of the present invention will become more apparent and more readily appreciated from the following description of the exemplary embodiments, taken in conjunction with the accompanying drawings of which:

FIG. 1 shows an exhaust pipe of a diesel internal combustion engine with a built-in sensor in a semi-sectional basic illustration,

FIG. 2a is a view of the sensor in FIG. 1 in the direction of the arrow IIa and FIG. 2b is a view of the sensor in FIG. 1 in the direction of the arrow IIb,

FIG. 3 is a circuit diagram of a resonant circuit with a connected sensor from FIG. 1,

FIG. 4 is a graph of the voltage dropping across the sensor from FIG. 1 as a function of its ohmic resistance with wiring according to FIG. 3,

FIG. 5 is a graph of the deviation of the resonant frequency from maximum resonant frequency of the resonant circuit according to FIG. 3 plotted against the change in resistance of the sensor,

FIG. 6 is a block diagram of an alternative embodiment of a sensor with embedded electrodes in an illustration according to FIG. 1,

FIG. 7 is a circuit diagram of a resonant circuit with a connected sensor as illustrated in FIG. 6,

FIG. 8 is a block diagram of an alternative embodiment of a sensor with electrodes mounted on the opposite side of the surface for the deposition of particles, in an illustration according to FIG. 1,

FIG. 9 shows an alternative embodiment of a sensor with a base body made of foamed ceramic in an illustration according to FIG. 1,

FIG. 10 shows the exhaust pipe of a diesel internal combustion engine according to FIG. 1 with built-in sensor according to FIG. 8 in an alternative installation position in an illustration according to FIG. 1, and

FIG. 11 is a plan view of the sensor from FIG. 10 in the direction of the arrow XI, in an illustration according to FIG. 2.

### DETAILED DESCRIPTION OF THE PREFERRED EMBODIMENTS

Reference will now be made in detail to the preferred embodiments of the present invention, examples of which are illustrated in the accompanying drawings, wherein like reference numerals refer to like elements throughout.

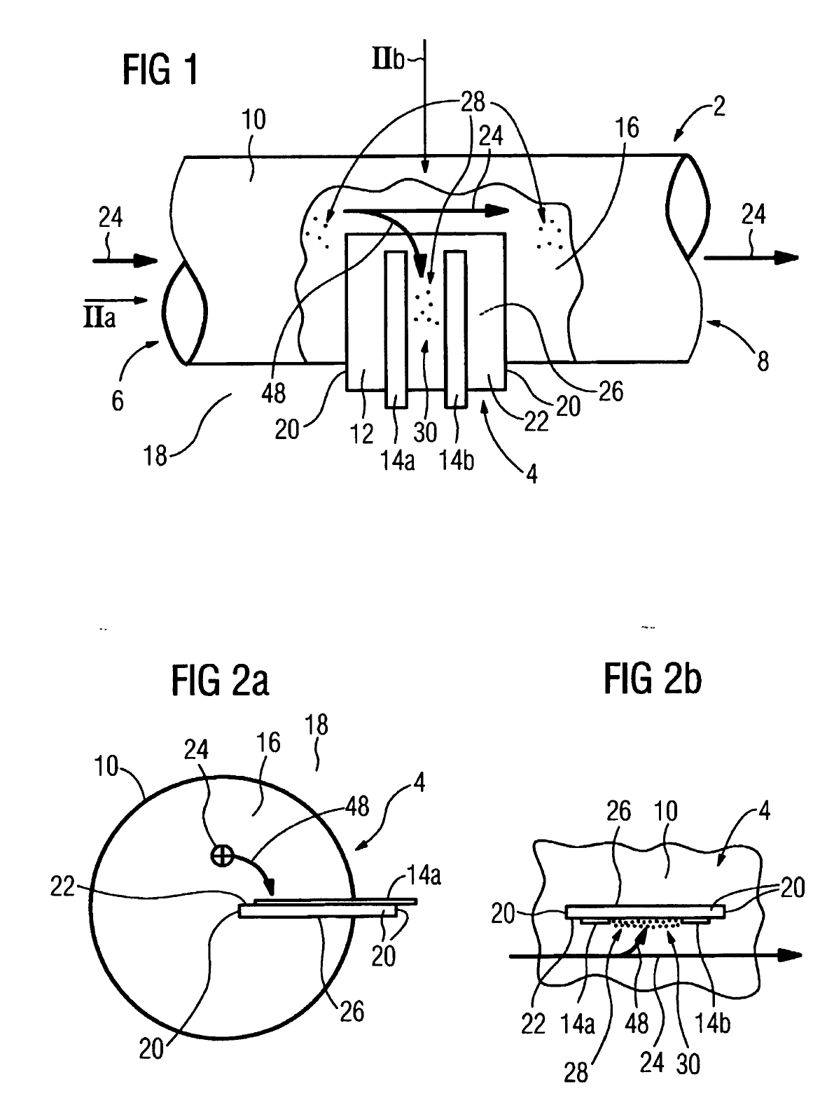

FIG. 1 shows a detail of an exhaust pipe 2 of a diesel internal combustion engine (not illustrated). A sensor 4 is mounted on the exhaust pipe 2. The end 6 of the exhaust pipe 2 firstly leads to a particle filter (not illustrated) and from there to the internal combustion engine (not illustrated). The exhaust pipe 2 leads on from the end 8 to an exhaust end (not illustrated).

FIG. 1 shows the wall 10 of the exhaust pipe 2 in partially cut-away form, giving a view of the sensor 4. The sensor 4 includes a base body 12 and an electrode pair 14a, b which is mounted thereon. The sensor 4 is inserted with its base body 12 into the wall 10 of the exhaust pipe 2 in such a way that it points partially into the interior 16 of the exhaust pipe 2 and partially into the external space 18 surrounding the exhaust pipe 2. The wall 10 is connected here in a fixed and sealed fashion with respect to exhaust gases to two side faces 20 and the front side 20 and rear side 26 of the base body 12 on a circumferential line. The upper side 22 of the base body 12 which bears the electrodes 14a, b thus lies partially in the interior 16 of the exhaust pipe 2 and is thus connected to exhaust gas which flows through the exhaust pipe 2 in the direction indicated by the arrows 24. Other arrangements of the sensor 4 on the exhaust pipe 2 are also conceivable, as is specified further below.

Particles 28 which are transported along by the exhaust gas in the exhaust gas direction 24 are partially deposited in the region 30 of the side 22 between the electrodes 14a, b. This is illustrated by the arrow 48. The sensor 4 is placed favorably in the exhaust gas stream 24 in terms of flow dynamics such that as many particles as possible are deposited on it. For example, baffle plates or deflector plates in its environment (also not illustrated) also serve this purpose. An electrical connecting line is attached to each of the electrodes 14a, b, the connecting lines being respectively not illustrated and leading away from the sensor 4.

FIG. 2a shows the sensor 4 from FIG. 1 in the viewing direction of the arrow IIa, and FIG. 2b shows the view in the direction of the arrow IIb. Only the end face 20 of the sensor 4 stands in the way of the exhaust gas flowing toward it in the direction 24 and thus offers as little flow resistance as possible. The electrode 14a which is elevated above the side face 22 has a detachment edge for the exhaust gas flow on its side lying downstream so that exhaust gas and thus particles eddy and become deposited in the region 30 between the two electrodes 14a, b. When a large number of particles 28 are deposited in the region 30, a layer which conductively connects the electrodes 14a and 14b is formed there. An electrical direct current path is produced.

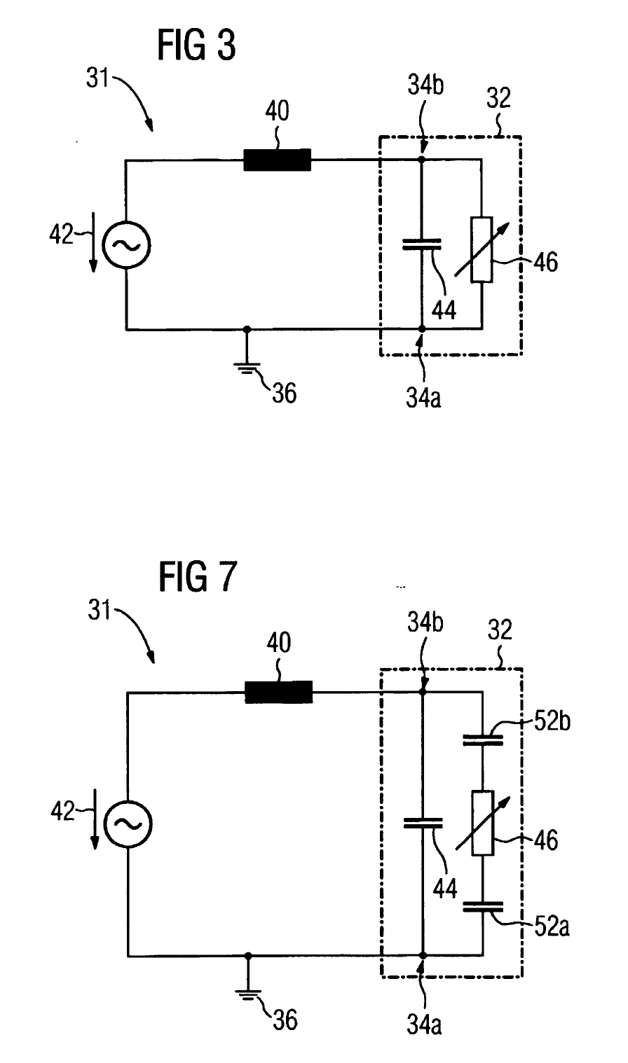

FIG. 3 shows the circuit diagram of a resonant or oscillating circuit in which the sensor 4 according to FIGS. 1 and 2 is operated. The equivalent circuit diagram of the sensor 4 corresponds to the circuit component 32 which is outlined. The electrode 14a, which corresponds to the node 34a, is connected to the vehicle ground 36. The node 34b which corresponds to the electrode 14b is connected via an inductor 40 to a voltage source 42 for alternating voltage, which is in turn connected to ground 36.

When alternating voltage is applied, the equivalent circuit diagram 32 of the sensor 4 contains a capacitor 44 and an ohmic resistor 46 which are connected in parallel. Overall, FIG. 3 thus shows a series oscillating circuit. The values of the capacitor 44 and of the resistor 46 change depending on the quantity of particles 28 deposited in the region 30. As a result, characteristic variables of the oscillating circuit such as its natural frequency, quality or the division ratio of the voltage dropping across the circuit component 32 with respect to the voltage of the voltage source 42 also change.

In order to be able to make quantitative statements about the particle load of the sensor 4, first at least one of these respective characteristic variables, that is to say for example according to the first method variant the voltage dropping across the sensor 4 (and thus at the circuit component 32) is determined and stored as a reference value when the sensor is still not yet loaded. This is done using an electronic measuring circuit (not illustrated), for example a capacitive divider and comparators. If the same characteristic variable, that is to say the voltage, is determined once more at a later time, it is compared with the stored reference value. The deviation of the current measured value of the voltage with respect to the reference value is then a quantitative measure of the amount of particles 28 deposited on the sensor 4.

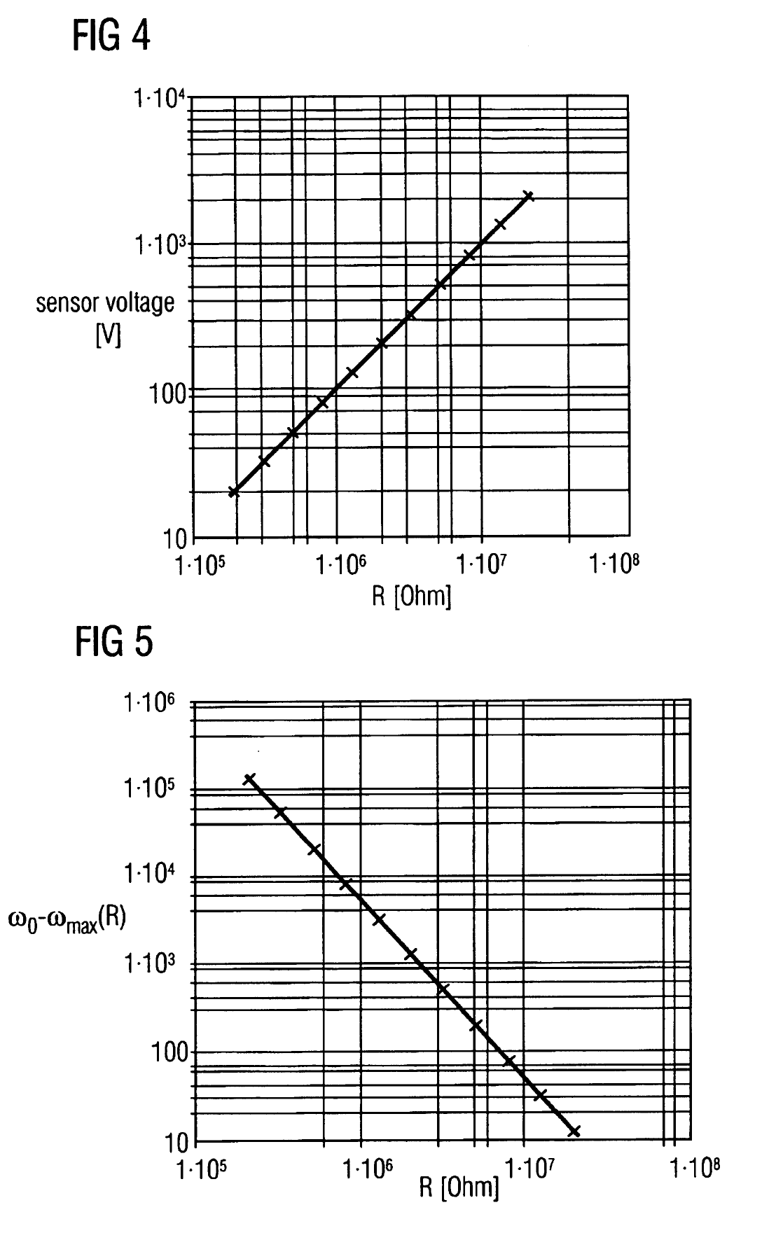

The circuit according to FIG. 3 is the basis for the diagram in FIG. 4. The amplitude of the source voltage of the voltage source 42 is 10 V. The impedance of the loss-free circuit (resistance 46 is infinitely large) is 100 kΩ and the resonant frequency is then 2 MHz. In the diagram, the value of the resistance 46 is plotted on the abscissa in the range 100 kΩ to 100 MΩ. The curve describes the sensor voltage (ordinate) which is associated with the respective resistance and which drops across the circuit component 32 and lies in the range from approximately 20 V to 2000 V. The property of the excessive increase in the voltage of the oscillating circuit, specifically factor 2 to 200 with respect to the exciting voltage of 10 V, can be seen in this.

By measuring the voltage at the partial network 32, that is to say at the sensor 4, it is possible to determine very precisely the value of the resistance 46 using the diagram, which in turn permits precise statements to be made about the amount of particles 28 in the region 30 and thus about the total amount of particles located in the exhaust gas stream 24.

The diagram in FIG. 5 shows in turn the deviation of the resonant frequency from the resonant frequency of 2 MHz of the loss-free circuit for the same resistance range as in FIG. 4 of the resistor 46. Given a value of approximately 800 kΩ of the resistor 46, the deviation is 10 kHz, that is to say in this case the resonant frequency of the entire circuit according to FIG. 3 has increased to 2.01 MHz. From the diagram according to FIG. 5 it is therefore possible to infer the resistance value precisely by measuring the resonant frequency in the oscillating circuit.

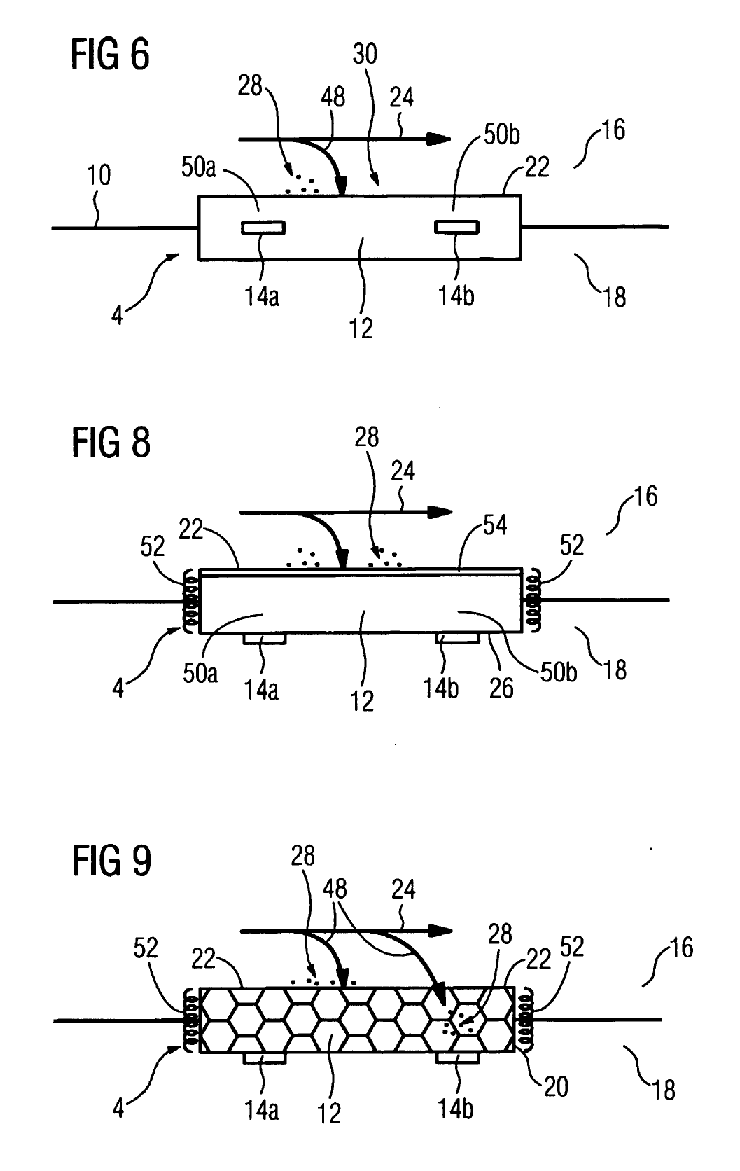

FIG. 6 shows a sensor 4 in the state in which it is installed in the exhaust pipe 2 corresponding to FIG. 1, only the side wall 10 of the exhaust pipe 2 being visible in section. However, in contrast to the embodiment according to FIG. 1, the electrodes 14a, b are embedded in the interior of the base body 12 so that they are not in contact with the interior space 16. This has the advantage that the electrodes 14a, b are not subjected to the exhaust gas flowing in the direction 24, which makes the sensor 4 significantly more robust compared to the embodiment according to FIG. 1. Particles 28 can nevertheless become deposited out of the exhaust gas stream 24 in the direction 48 from the side 22 of the sensor 4.

Although the particles 28, which can also form a continuous conductive layer on the side 22 when the density is sufficient, cannot come into direct contact with the electrodes 14a, b, the particles 28 nevertheless influence the loss or capacitance properties of the sensor 4 when alternating voltage is applied to it. Since the electrodes 14a, b are embedded in the nonconductive base body 12, the coupling to the particles 28 which determine the losses takes place capacitively in the regions 50a, b.

Therefore, compared to FIG. 3, the equivalent circuit diagram 32 in FIG. 7 which is associated with the sensor 4 according to FIG. 6 has two additional coupling capacitors 52a, b which represent the regions 50a, b in the equivalent circuit diagram 32. The coupling capacitors 52a, b are connected in series on each side to the resistor 46, and this branch is connected in parallel with the sensor capacitor 44. The wiring of the sensor 4 which forms again a series oscillating circuit in FIG. 7 is identical to that in FIG. 3.

Given suitable corresponding dimensions, the respective coupling capacitors 52a, b can be selected to be of such a magnitude that they are negligible in the circuit diagram according to FIG. 7, and this can be simplified again with respect to the circuit diagram according to FIG. 3. The dimensioning can easily be achieved since the distance between the sensor electrodes 14a, b and the side 22, and thus the particle layer which is produced there can always be kept smaller than the distance between the actual sensor electrodes 14a, b, and capacitors are inversely proportional to the distances of the electrodes which form them.

FIG. 8 shows a further embodiment of a sensor 4 in which the electrodes 14a, b are mounted on the side 26, that is to say on the side of the base body 12 facing the exterior space 18, on the surface of the base body 12. In the embodiment according to FIG. 8, the electrodes 14a, b are not subjected, as in FIG. 6, to the interior space 16 and thus to the exhaust gases in the exhaust pipe 2, and are thus also subject to significantly less wear. At the sensor 4, or in its vicinity, electrical resistance heating coils 52 are mounted, with which coils 52 the base body 12 can be heated in particular in the region of the side 22. Given a smaller degree of heating, it is thus possible to allow for the fact that apart from the particles 28 no other condensates are precipitated on the side 22, which condensates would falsify the impedance of the sensor 4. Given further heating of the sensor 4 by the heating coil 50, it is also possible to ensure that the particles 28 themselves burn off and the side 22 is thus cleaned again and free of particles. This makes it possible to return the sensor 4 to a state in which it is not loaded by particles 28, in order to carry out a new reference measurement. In order to simplify the burning-off of particles 28 from the side 22 of the base body 12, the side is coated with a catalytically active layer 54 which lowers the ignition temperature of the particles 28. The side 22 therefore does not need to be heated so much by the heating coil 52 as it would be without the catalytic layer 54.

FIG. 9 shows once more the sensor 4 in an embodiment similar to FIG. 8, its base body 12 not being composed of a fixed, sealed material but rather of a porous material, for example a foamed ceramic. Particles 28 which are transported by the exhaust gas stream 24 can therefore be precipitated in the direction of the arrow 48 not only on the surface 22 of the base body 12 but also in its volume. The particles 28 are thus retained better on the base body 12 and are not torn away again by the exhaust gas stream 24. The sensor 4 in the embodiment according to FIG. 9 can therefore absorb significantly more particles 28 than in the other embodiments shown, as a result of which its electrical properties can be varied to a greater degree and the measuring accuracy of the overall system can thus be increased further.

Heating coils 52 are also provided for this embodiment. The heating coils 52 are supplied by a separate heating voltage source (not illustrated). The heating coils must not have a conductive connection to the electrodes 14a, b so as to not influence the measurements in the resonant circuit, and they must also be located outside the field region of the electrodes 14a, b in order to avoid influencing the capacitive properties of the sensor 4 too much.

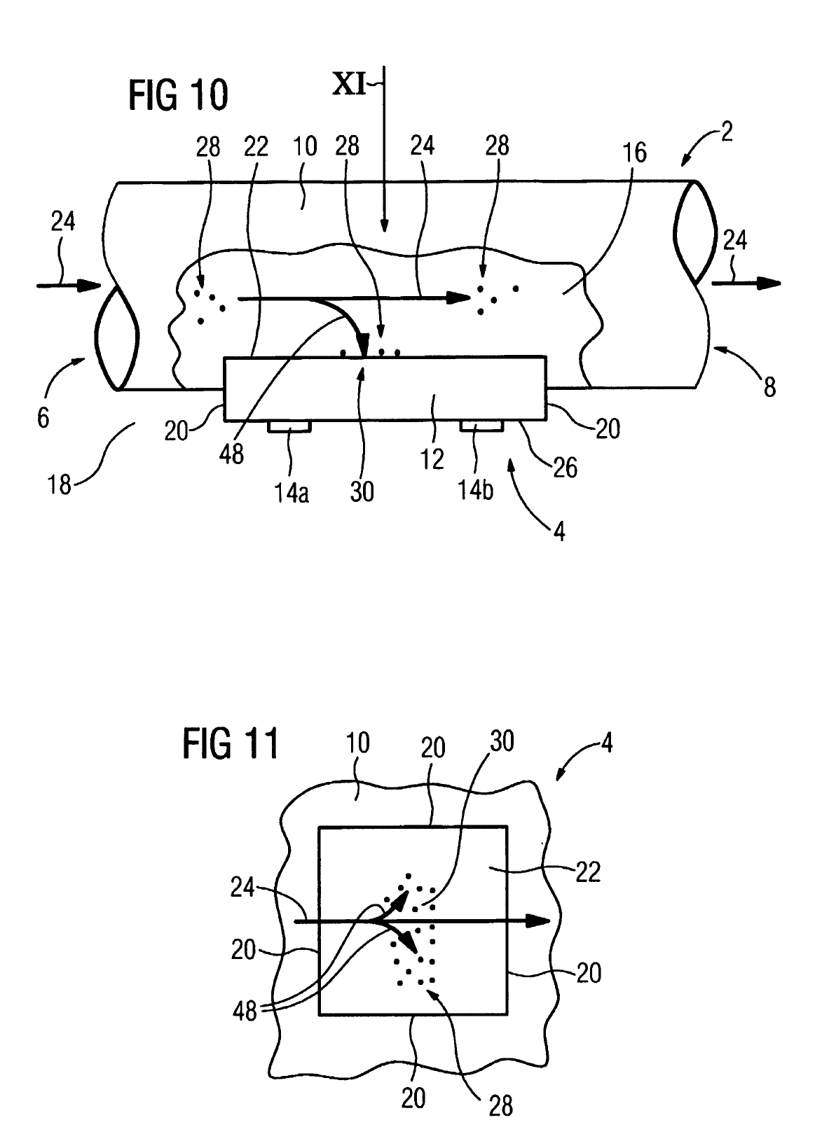

FIG. 10 shows an alternative arrangement possibility of the sensor 4 in the exhaust pipe 2, which possibility is appropriate for its embodiment according to FIG. 8. Here, the wall 10 encloses the side face 20 over its entire circumference in a sealed and precisely fitting fashion. The side 22 of the sensor 4 thus lies entirely in the interior 16 of the pipe, and the side 26 together with the electrodes 14a, b lies entirely in the exhaust gas-free external space 18.

FIG. 11 shows the view from FIG. 10 in the direction of the arrow XI. Therefore, only the surface 22 of the sensor can be reached by exhaust gases and particles 28 from the internal space 16. In the external space 18, the electrodes are thus protected against the aggressive exhaust gases.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. A method for monitoring particle concentration in a gas stream, comprising:
collecting particles by a sensor in the gas stream, the sensor integrated as a capacitive element into an electromagnetic resonant circuit;
exciting the resonant circuit with an alternating voltage;
determining a characteristic variable of the resonant circuit which can vary as a result of particle load of the sensor, as a reference value when the sensor is not loaded, where the characteristic variable is one of a resonant frequency of the resonant circuit and a voltage across the sensor when the resonant circuit is excited by the alternating voltage having a fixed frequency and fixed amplitude; and
determining a change in the characteristic variable brought about by the particle load compared to the reference value.

12. The method as recited in claim 11, wherein the frequency of the alternating voltage exciting the resonant circuit is tuned to a respective resonant frequency of the resonant circuit, and the frequency of the exciting voltage is determined as the characteristic variable.

13. The method as recited in claim 12, further comprising heating the sensor, during said determining of the characteristic variable, to a temperature below an ignition temperature of the particles and sufficient to remove impurities adhering to the sensor.

14. The method as recited in claim 13, further comprising heating the sensor, before said determining of the characteristic variable, to a temperature above the ignition temperature of the particles and sufficient to remove a particle load.

15. The device as recited in claim 14, wherein the particles are soot particles in an exhaust gas stream of an internal combustion engine.

16. A device, excited with alternating voltage, for monitoring particle concentration in a gas stream, comprising:
an electromagnetic resonant circuit excited with the alternating voltage;
a sensor in the gas stream, integrated as a capacitive element into the electromagnetic resonant circuit, collecting particles, having a nonconductive base body made of porous material and two electrodes spaced apart from one another; and
a characteristic variable determiner determining change in a characteristic variable of the electromagnetic resonant circuit, the characteristic variable varying as a result of particle load of said sensor, from a reference value determined when said sensor is not loaded due to having been heated above an ignition temperature of the particles, where the characteristic variable is one of a resonant frequency of the resonant circuit and a voltage across the sensor when the resonant circuit is excited by the alternating voltage having a fixed frequency and fixed amplitude.

17. The device as recited in claim 16, wherein the nonconductive base body is composed of ceramic.

18. The device as recited in claim 17, wherein the electrodes are embedded in the nonconductive base body.

19. The device as recited in claim 18, wherein the electrodes are arranged on a side of the nonconductive base body inaccessible to the particles.

20. The device as recited in claim 19, further comprising a heating device heating said sensor above the ignition temperature of the particles prior to determining the reference value of the characteristic variable.

21. The device as recited in claim 20, wherein the base body includes a catalytically active layer.

22. The device as recited in claim 22, wherein the particles are soot particles in an exhaust gas stream of an internal combustion engine.
